(19) United States
(12) Patent Application Publication
(10) Pub. No.: US 2014/0002221 A1
(43) Pub. Date: Jan. 2, 2014

(54) POWER INDUCTOR AND METHOD OF MANUFACTURING THE SAME

(71) Applicant: Sung Sik SHIN, Suwon (KR)

(72) Inventor: Sung Sik SHIN, Suwon (KR)

(21) Appl. No.: 13/613,412

(22) Filed: Sep. 13, 2012

(30) Foreign Application Priority Data
Jun. 29, 2012 (KR) 10-2012-0070524

(51) Int. Cl. H01F 27/24; H01F 7/06

(52) U.S. Cl. 336/83; 29/602.1

(57) ABSTRACT

There is provided a power inductor including: a magnetic body including metal powder particles having surfaces thereof coated with a ferrite and a polymer resin; internal electrodes formed in the interior of the magnetic body; and external electrodes formed on the exterior of the magnetic body and electrically connected to the internal electrodes.

### CROSS-REFERENCE TO RELATED APPLICATIONS

This application claims the priority of Korean Patent Application No. 10-2012-0070524 filed on Jun. 29, 2012, in the Korean Intellectual Property Office, the disclosure of which is incorporated herein by reference.

### BACKGROUND OF THE INVENTION

1. Field of the Invention

The present invention relates to a power inductor capable of implementing maximum capacitance while simultaneously reducing material loss through insulation, and a method of manufacturing the same.

2. Description of the Related Art

Examples of electronic components using a ceramic material include a capacitor, an inductor, a piezoelectric element, a varistor, a thermistor, and the like.

Among these ceramic electronic components, an inductor, an important passive element configuring an electronic circuit, together with a resistor and a capacitor, may mainly be used as a component for removing noise or configuring an LC resonance circuit.

An inductor may be manufactured by winding coils around a ferrite core or printing a coil pattern on the ferrite core and forming electrodes at both ends thereof, or may be manufactured by printing internal electrodes on a magnetic material or a dielectric material and then stacking layers of the magnetic material or the dielectric material.

An inductor may be divided into one of several types thereof, such as a multilayered type inductor, a winding type inductor, a thin film type inductor, and the like, according to a structure thereof. Manufacturing methods of the respective inductors, in addition to ranges of application thereof, differ.

Among the types of inductors, the winding type inductor may be formed by winding coils around, for example, a ferrite core. However, in a case in which the number of windings is increased in order to obtain high inductance, stray capacitance between coils, that is, capacitance between conducting wires may be generated, such that high frequency characteristics are deteriorated.

In addition, a power inductor may be manufactured as a laminated body in which ceramic sheets formed of a plurality of ferrite or low-k dielectric materials are stacked.

Here, the ceramic sheets may have coil type metal patterns formed thereon. The coil type metal patterns formed on the respective ceramic sheets may be sequentially connected to each other by conductive vias formed in the respective ceramic sheets, and may form an overlapping structure in a vertical direction in which the ceramic sheets are stacked.

According to the related art, an inductor body configuring the power inductor has generally been formed of a quaternary ferrite material including nickel (Ni), zinc (Zn), copper (Cu) and iron (Fe).

However, this ferrite material has a saturation magnetization value lower than that of metal, such that high current characteristics required in a recent electronic product may not be able to be implemented therein.

Meanwhile, in the case in which the inductor body of the power inductor is formed of a metal component, the saturation magnetization value may be relatively increased as compared to the case in which the inductor body is formed of ferrite. However, in this case, eddy current loss and hysteresis loss may be increased at a high frequency, such that material loss may be intensified.

In order to reduce material loss, according to the related art, a structure in which metal powder particles are insulated from each other with a polymer resin has been used. However, in this case, a volume fraction of metal may be decreased, such that an effect of increasing a saturation magnetization value by the use of the metal component, may not be sufficiently implemented.

Patent Document 1 has disclosed that a power inductor includes an oxidation layer formed by oxidizing soft magnetic particles. However, in Patent Document 1, a saturation magnetization value may be decreased due to insulation.

Further, Patent Document 2 has disclosed that a power inductor includes a magnetic metal in which surfaces of magnetic metal powder particles are covered with glass. However, it may be difficult to implement capacitance in the power inductor, and DC-bias characteristics may be deteriorated.

### RELATED ART DOCUMENT

(Patent Document 1) Japanese Patent Laid-Open Publication No. 2011-249836
(Patent Document 2) Japanese Patent Laid-Open Publication No. 2008-226960

### SUMMARY OF THE INVENTION

An aspect of the present invention provides a power inductor capable of implementing maximum capacitance simultaneously with reducing material loss through insulation, and a method of manufacturing the same.

According to an aspect of the present invention, there is provided a power inductor including: a magnetic body including metal powder particles having surfaces thereof coated with a ferrite and a polymer resin; internal electrodes formed in the interior of the magnetic body; and external electrodes formed on the exterior of the magnetic body and electrically connected to the internal electrodes.

The metal powder particles may be selected from a group consisting of iron-nickel (Fe—Ni), iron-nickel-silicon (Fe—Ni—Si), iron-aluminum-silicon (Fe—Al—Si), and iron-aluminum-chrome (Fe—Al—Cr).

The power inductor may further include cover layers formed as a top layer and a bottom layer of the magnetic body, respectively.

The cover layers may include the metal powder particles having the surfaces thereof coated with the ferrite and the polymer resin.

The metal powder particles may include a mixture of at least two metal powder particles having different particle diameters.

The metal powder particles may have an average particle diameter of 1 to 50 μm.

The ferrite may include at least one ferrite oxide selected from a group consisting of nickel ferrite (Ni Ferrite), zinc ferrite (Zn Ferrite), copper ferrite (Cu Ferrite), maganese ferrite (Mn Ferrite), cobalt ferrite (Co Ferrite), barium ferrite (Ba Ferrite), and nickel-zinc-copper ferrite (Ni—Zn—Cu Ferrite).

The polymer resin may include at least one selected from a group consisting of a novolac epoxy resin, a phenoxy type epoxy resin, a BPA type epoxy resin, a BPF type epoxy resin, a hydrogenated BPA epoxy resin, a dimer acid modified epoxy resin, a urethane modified epoxy resin, a rubber modified epoxy resin, and a DCPD type epoxy resin.

The internal electrodes may include at least one of silver (Ag), copper (Cu), and a copper alloy.

The magnetic body may be formed by stacking sheets including the metal powder particles having the surfaces thereof coated with the ferrite.

According to another aspect of the present invention, there is provided a method of manufacturing a power inductor, the method including: preparing a plurality of sheets formed of a material including metal powder particles having surfaces thereof coated with a ferrite and a polymer resin; forming internal electrodes on the plurality of sheets, respectively; and forming a magnetic body by stacking the plurality of sheets having the internal electrodes formed thereon.

After the forming of the magnetic body, the method may further include forming cover layers as top and bottom layers of the magnetic body, respectively, the cover layers being formed of the material including the metal powder particles having the surfaces thereof coated with the ferrite and the polymer resin.

The cover layers may be formed by stacking the plurality of sheets formed of the material including the metal powder particles having the surfaces thereof coated with the ferrite and the polymer resin.

The cover layers may be formed by printing a paste to form the top and bottom surfaces of the magnetic body, respectively, the paste being formed of the material including the metal powder particles having the surfaces thereof coated with the ferrite with the polymer resin.

After the forming of the magnetic body, the method may further include forming external electrodes on the exterior of the magnetic body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a structure of a power inductor according to an embodiment of the present invention;

FIG. 2 is a cross-sectional view taken along line A-A′ of FIG. 1; and

FIGS. 3A through 3C are views illustrating a process of manufacturing a power inductor according to another embodiment of the present invention.

### DETAILED DESCRIPTION OF THE EMBODIMENTS

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the accompanying drawings, the same reference numerals will be used to designate the same or like elements.

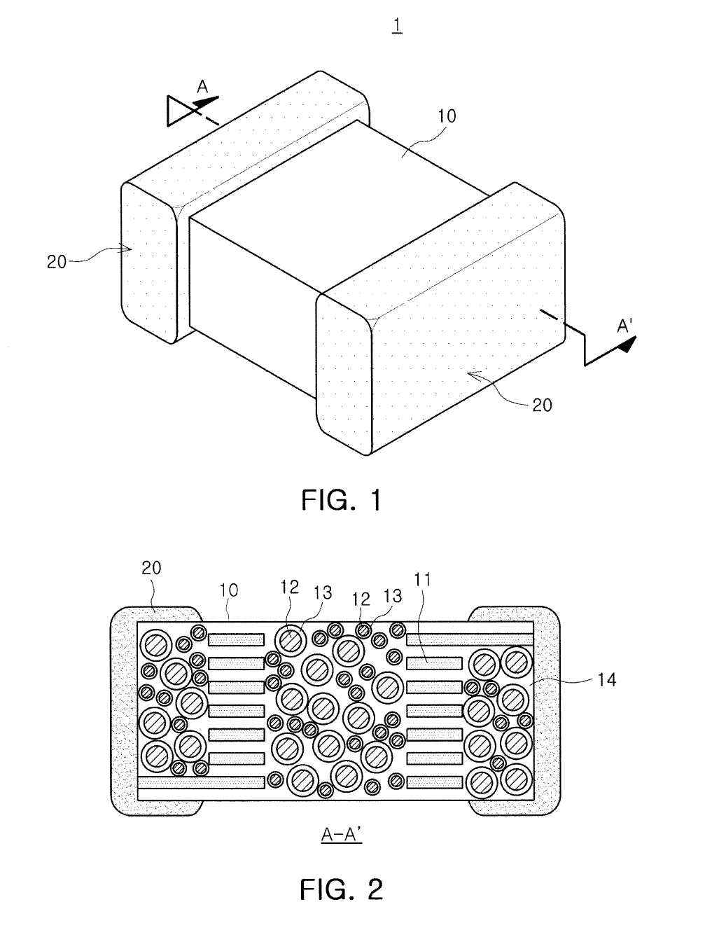

FIG. 1 is a perspective view illustrating a structure of a power inductor according to an embodiment of the present invention.

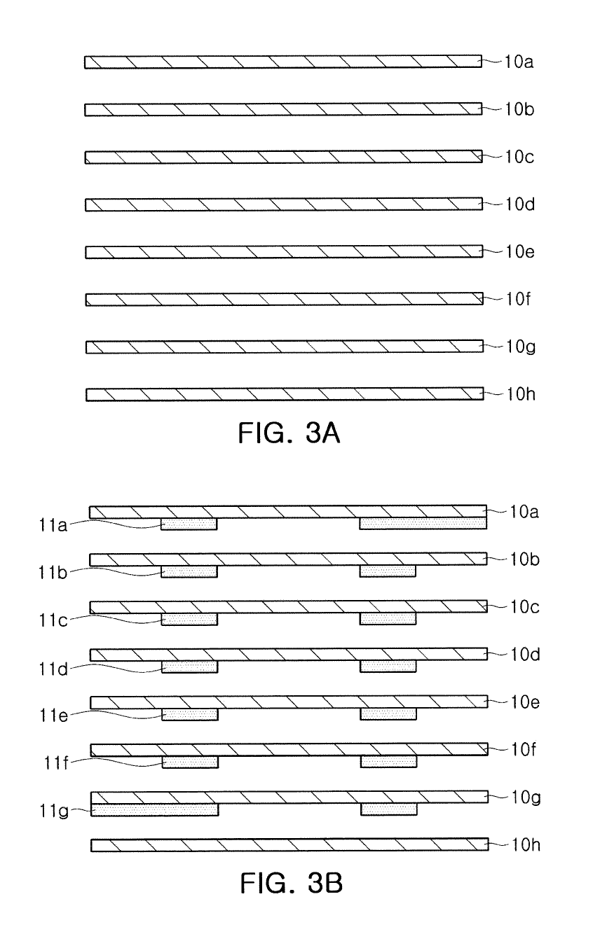

FIG. 2 is a cross-sectional view taken along line A-A′ of FIG. 1.

Referring to FIGS. 1 and 2, a power inductor 1 according to an embodiment of the present invention may include a magnetic body 10 including metal powder particles 12 having surfaces coated with a ferrite 13 and a polymer resin 14; internal electrodes 11 formed in the interior of the magnetic body 10; and external electrodes 20 formed on the exterior of the magnetic body 10 and electrically connected to the internal electrodes 11.

The metal powder particles 12 included in the magnetic body 10 may have various diameters. For example, the metal powder particles may have an average particle diameter of 1 to 50 μm, but are not limited thereto.

In addition, in the case of the metal powder particles 12, only particles having the same diameter may be used therefor. However, the present invention is not limited thereto. For example, at least two particles having different diameters, e.g. a mixture of metal powder particles having a diameter of 30 μm and metal powder particles having a diameter of 3 μm may be used.

In the case in which at least two particles having different diameters, as described above, are used, a packing factor of the magnetic body 10 is increased by as much as possible, whereby capacitance of the power inductor may be implemented to be as high as possible.

For example, in the case in which the metal powder particles having the diameter of 30 μm are used, interstices may be generated between the metal powder particles having the diameter of 30 μm.

In this case, the packing factor of the magnetic body 10 may be decreased due to the interstices. However, the mixture of the metal powder particles having a diameter of 30 μm and the metal powder particles having a diameter of 3 μm is used, whereby the packing factor may be increased by as much as possible.

That is, the interstices are filled with the metal powder particles having the diameter of 3 μm, such that the interstices may be reduced by as much as possible. Therefore, the packing factor of the magnetic body 10 is increased by as much as possible, whereby the capacitance of the power inductor may be maximized.

The metal powder particles 12 may be formed of a material including at least one selected from a group consisting of iron-nickel (Fe—Ni), iron-nickel-silicon (Fe—Ni—Si), iron-aluminum-silicon (Fe—Al—Si), andiron-aluminum-chrome (Fe—Al—Cr). However, the present invention is not limited thereto.

According to the embodiment of the present invention, the metal powder particles 12 may have surfaces coated with the ferrite 13.

The ferrite 13 may be at least one ferrite oxide selected from a group consisting of nickel ferrite (Ni Ferrite), zinc ferrite (Zn Ferrite), copper ferrite (Cu Ferrite), manganese ferrite (Mn Ferrite), cobalt ferrite (Co Ferrite), barium ferrite (Ba Ferrite), and nickel-zinc-copper ferrite (Ni—Zn—Cu Ferrite). However, the present invention is not limited thereto.

In order to implement capacitance of an inductor, a method of using a mixture of at least two metal powder particles having different average particle diameters in a magnetic body to increase a packing factor by as much as possible has generally been used.

In this case, the packing factor of the magnetic body is increased by as much as possible, such that the capacitance of the power inductor may be implemented as high as possible. However, the average particle diameter of the metal powder particles is increased, such that eddy current loss may be increased.

In order to solve this problem, the surfaces of the metal powder particles are coated with glass, whereby eddy current loss due to the metal powder particles may be suppressed.

However, since the surfaces of the metal powder particles are coated with glass in order to suppress the eddy current loss, an interval between the metal powder particlesmay be increased, such that the capacitance of the power inductor may be decreased.

According to the embodiment of the present invention, the surfaces of the metal powder particles 12 are coated with the ferrite 13, such that insulation characteristics may be implemented therein, whereby eddy current loss may be suppressed.

In addition, the surfaces of the metal powder particles 12 are coated with the ferrite 13 to thereby increase a volume fraction of the magnetic materials and decrease an interval between the magnetic materials, whereby the capacitance of the power inductor may be implemented to be as high as possible.

That is, the surfaces of the metal powder particles 12 are coated with the ferrite 13 to thereby increase the volume fraction of the magnetic materials, whereby the capacitance of the power inductor may be maximized, and the ferrite, an insulating material, is disposed between the metal powder particles, whereby an inductor having high reliability even at a high temperature may be implemented.

Further, the polymer resin 14 included in the magnetic body 10 provides insulation between the plurality of metal powder particles 12, and may be a thermosetting resin.

The thermosetting resin may include at least one selected from a group consisting of, for example, a novolac epoxy resin, a phenoxy type epoxy resin, a BPA type epoxy resin, a BPF type epoxy resin, a hydrogenated BPA epoxy resin, a dimer acid modified epoxy resin, a urethane modified epoxy resin, a rubber modified epoxy resin, and a DCPD type epoxy resin.

According to the embodiment of the present invention, the magnetic body 10 may be formed by stacking a plurality of sheets formed of a material including the metal powder particles 12 having the surfaces thereof coated with the ferrite 13 and the polymer resin 14.

However, the magnetic body 10 according to the embodiment of the present invention is not limited to being formed by the above-mentioned method, but may be formed by various methods as needed. For example, the magnetic body 10 may be formed by printing a paste formed of the material including the metal powder particles 12 having the surfaces thereof coated with the ferrite 13 and the polymer resin 14 to have a predetermined thickness or be formed by inserting the paste into a frame and then compressing the paste.

Here, the number of sheets stacked in order to form the magnetic body 10 or a thickness of the paste printed in order to form the magnetic body 10 may be appropriately determined in consideration of electrical characteristics such as inductance, and the like, required in the power inductor 1.

The sheets forming the magnetic body 10 may include respective internal electrodes formed on one surfaces thereof and a conductive via (not shown) penetrating therethrough so as to form a connection with internal electrodes positioned on upper and lower levels thereto, in a thickness direction thereof.

Therefore, one ends of the internal electrodes formed on the individual sheets may be electrically connected to each other through the conductive via formed in adjacent sheets.

In addition, both ends of the internal electrode are exposed to the outside through both ends of the magnetic body 10, respectively, such that they may be electrically connected to a pair of external electrodes 20 formed on both ends of the magnetic body 10, respectively, while contacting the pair of external electrodes 20.

The internal electrode may be formed by a thick film printing method, a paste applying method, a depositing method, a sputtering method, and the like. However, the present invention is not limited thereto.

The conductive via may be formed by forming a through-hole in each sheet in the thickness direction and then filling the through-hole with a conductive paste, or the like. However, the present invention is not limited thereto.

In addition, the material forming the internal electrode and the conductive paste forming the conductive via may be formed of a material including at least one of silver (Ag), copper (Cu), and a copper alloy. However, the present invention is not limited thereto.

Further, the power inductor 1 may further include cover layers 10a and 10h formed as a top layer and a bottom layer of the magnetic body 10, respectively.

These cover layers 10a and 10h may be formed of the material including the metal powder particles 12 having the surfaces thereof coated with the ferrite 13 and the polymer resin 14, the same materials as those forming the magnetic body 10, as needed. However, the present invention is not limited thereto.

Here, the metal powder particles 12 included in the cover layers 10a and 10h may have various diameters.

The external electrodes 20 may be formed at both ends of the magnetic body 10, respectively, so as to cover end portions of the magnetic body 10, and may be electrically connected to both ends of the internal electrodes 11 exposed through both ends of the magnetic body 10, respectively, while contacting both ends of the internal electrodes 11.

These external electrodes 20 may be formed at both ends of the magnetic body 10 by various methods such as a method of immersing the magnetic body 10 in a conductive paste, a printing method, a depositing method, a sputtering method, and the like.

The conductive paste may be formed of a material including one of, for example, silver (Ag), copper (Cu), and a copper (Cu) alloy. However, the present invention is not limited thereto.

Further, the power inductor 1 may further include a nickel (Ni) plating layer (not shown) and a tin (Sn) plating layer (not shown) formed on an outer surface thereof, as needed.

Next, an operation of the power inductor according to the embodiment of the present invention will be described.

In the power inductor, in the case in which the inductor body is formed only of a ferrite material, since a saturation magnetization value is relatively lower as compared to the case in which the inductor body is formed of a metal material, inductance may be seriously deteriorated at the time of the use of high current, such that it is difficult to implement a desired inductance value at high current.

Further, in the case in which the inductor body is formed of a metal material, the saturation magnetization value is high; however, eddy current loss and hysteresis loss may be increased at a high frequency, such that loss of a material may be intensified.

However, according to the embodiment of the present invention, since the magnetic body 10 includes the metal powder particles 12 having the surfaces thereof coated with the ferrite 13 and the polymer resin 14, a decrease in an inductance (L) value at high current may be prevented using the advantages of the metal material.

Further, the volume fraction of the magnetic materials in the magnetic body 10 is increased and the interval between the magnetic materials is decreased, by the ferrite 13 included in the magnetic body 10, whereby the capacitance of the power inductor 1 may be increased.

Hereinafter, a method of manufacturing a power inductor according to another embodiment of the present invention will be described.

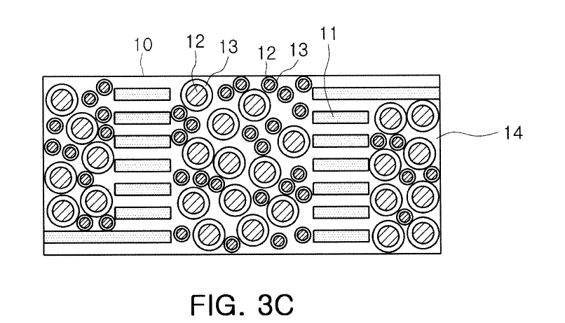

FIGS. 3A through 3C are views illustrating a process of manufacturing a power inductor according to another embodiment of the present invention.

Referring to FIGS. 3A through 3C, in the method of manufacturing a power inductor according to another embodiment of the present invention, a plurality of sheets formed of a material including metal powder particles having surfaces thereof coated with a ferrite and a polymer resin may first be prepared.

Next, internal electrodes may be formed on the plurality of sheets, respectively, and the plurality of sheets may be stacked to form a magnetic body.

The internal electrodes may be formed on the sheets using a conductive material by a thick film printing method, a paste applying method, a depositing method, a sputtering method, or the like. However, the present invention is not limited thereto.

In addition, a through-hole may be formed in each sheet and be then filled with a conductive paste, or the like, to form a conductive via. However, the present invention is not limited thereto.

Then, a plurality of sheets formed of a mixture of metal powder particles having surfaces thereof coated with a ferrite and a polymer resin may be stacked to form cover layers.

Meanwhile, the cover layers may be formed by printing a paste formed of the material including the metal powder particles having the surfaces thereof coated with the ferrite and the polymer resin on top and bottom surfaces of the magnetic body 10 to have a predetermined thickness, respectively, instead of being formed by stacking the plurality of sheets.

Thereafter, the magnetic body 10 is sintered, and external electrodes 20 are formed at both ends of the magnetic body 10 so as to be electrically connected to both ends of the internal electrodes 11 exposed through both ends of the magnetic body 10, respectively.

Here, the external electrodes 20 may be formed by various methods such as a method of immersing the magnetic body 10 in a conductive paste, a printing method, a depositing method, a sputtering method, and the like.

The conductive paste may be formed of a material including one of, for example, silver (Ag), copper (Cu), and a copper alloy. However, the present invention is not limited thereto.

Next, a nickel (Ni) plating layer and a tin (Sn) plating layer may be further formed on an outer surface of the external electrode 20, as needed.

As set forth above, according to embodiments of the present invention, a magnetic body is configured to include metal powder particles having surfaces thereof coated with a ferrite and a polymer resin to implement insulation characteristics, whereby eddy current loss at high frequency may be decreased.

In addition, a volume fraction of the magnetic materials in the magnetic body is increased and an interval between the magnetic materials is decreased, by the ferrite included in the magnetic body, whereby the capacitance of the power inductor may be increased.

In addition, the ferrite, an insulating material, is disposed between the metal powder particles, whereby an inductor having high reliability, even at high temperatures, may be implemented.

While the present invention has been shown and described in connection with the embodiments, it will be apparent to those skilled in the art that modifications and variations can be made without departing from the spirit and scope of the invention as defined by the appended claims.

What is claimed is:

1. A power inductor comprising:
a magnetic body including metal powder particles having surfaces thereof coated with a ferrite and a polymer resin;
internal electrodes formed in the interior of the magnetic body; and
external electrodes formed on the exterior of the magnetic body and electrically connected to the internal electrodes.

2. The power inductor of claim 1, wherein the metal powder particles are selected from a group consisting of iron-nickel (Fe—Ni), iron-nickel-silicon (Fe—Ni—Si), iron-aluminum-silicon (Fe—Al—Si), and iron-aluminum-chrome (Fe—Al—Cr).

3. The power inductor of claim 1, further comprising cover layers formed as a top layer and a bottom layer of the magnetic body, respectively.

4. The power inductor of claim 3, wherein the cover layers include the metal powder particles having the surfaces thereof coated with the ferrite and the polymer resin.

5. The power inductor of claim 1, wherein the metal powder particles include a mixture of at least two metal powder particles having different particle diameters.

6. The power inductor of claim 1, wherein the metal powder particles have an average particle diameter of 1 to 50 μm.

7. The power inductor of claim 1, wherein the ferrite includes at least one ferrite oxide selected from a group consisting of nickel ferrite (Ni Ferrite), zinc ferrite (Zn Ferrite), copper ferrite (Cu Ferrite), maganese ferrite (Mn Ferrite), cobalt ferrite (Co Ferrite), barium ferrite (Ba Ferrite), and nickel-zinc-copper ferrite (Ni—Zn—Cu Ferrite).

8. The power inductor of claim 1, wherein the polymer resin includes at least one selected from a group consisting of a novolac epoxy resin, a phenoxy type epoxy resin, a BPA type epoxy resin, a BPF type epoxy resin, a hydrogenated BPA epoxy resin, a dimer acid modified epoxy resin, a urethane modified epoxy resin, a rubber modified epoxy resin, and a DCPD type epoxy resin.

9. The power inductor of claim 1, wherein the internal electrodes include at least one of silver (Ag), copper (Cu), and a copper alloy.

10. The power inductor of claim 1, wherein the magnetic body is formed by stacking sheets each including the metal powder particles having the surfaces thereof coated with the ferrite.

11. A method of manufacturing a power inductor, the method comprising:
preparing a plurality of sheets formed of a material including metal powder particles having surfaces thereof coated with a ferrite and a polymer resin;
forming internal electrodes on the plurality of sheets, respectively; and
forming a magnetic body by stacking the plurality of sheets having the internal electrodes formed thereon.

12. The method of claim 11, further comprising, after the forming of the magnetic body, forming cover layers as top and bottom layers of the magnetic body, respectively, the cover layers being formed of the material including the metal powder particles having the surfaces thereof coated with the ferrite and the polymer resin.

13. The method of claim 12, wherein the cover layers are formed by stacking the plurality of sheets formed of the material including the metal powder particles having the surfaces thereof coated with the ferrite and the polymer resin.

14. The method of claim 12, wherein the cover layers are formed by printing a paste to form the top and bottom surfaces of the magnetic body, respectively, the paste being formed of the material including the metal powder particles having the surfaces thereof coated with the ferrite with the polymer resin.

15. The method of claim 11, further comprising, after the forming of the magnetic body, forming external electrodes on the exterior of the magnetic body.
